(19) United States
(12) Patent Application Publication
(10) Pub. No.: US 2019/0082166 A1
(43) Pub. Date: Mar. 14, 2019

(54) ALIGNING METHOD FOR DUAL CAMERA MODULE

(71) Applicant: ISMEDIA CO., LTD., Gyeonggi-do (KR)

(72) Inventors: Ho Kyung SONG, Jeollabuk-do (KR); Eun Seok SHIN, Gyeonggi-do (KR); Han Byul CHAE, Seoul (KR); Sang Kyu YANG, Suwon-si (KR)

(73) Assignee: ISMEDIA CO., LTD., Gyeonggi-do (KR)

(21) Appl. No.: 15/889,268

(22) Filed: Feb. 6, 2018

(30) Foreign Application Priority Data
Sep. 12, 2017 (KR) 10-2017-0116535

(51) Int. Cl. H04N 13/246; G06T 7/80

(52) U.S. Cl. CPC H04N 13/246; G06T 2207/10012; G06T 2207/30204; G06T 7/85

(57) ABSTRACT

The present disclosure relates to an aligning method for dual camera module, the method having: a step of fixating a first camera module in a space inside a housing; a step of inserting a second camera module by moving the second camera module into the space inside the housing; a step of aligning the second camera module by aligning a position of the second camera module with reference to a position where the first camera module is fixated; and a step of fixating the second camera module in the space inside the housing. Accordingly, more particularly, it is possible to align the two camera modules with more convenience and accuracy.

### CLAIM OF PRIORITY

This application claims priority to Korean Application No. 10-2017-0116535 filed Sep. 12, 2017, the contents of which are hereby incorporated by reference in its entirety.

### FIELD OF THE EMBODIMENTS

The present disclosure relates to an aligning method for dual camera module, and more particularly, to an aligning method for dual camera module, capable of aligning the two camera modules with convenience and accuracy.

### BACKGROUND OF THE EMBODIMENTS

Smart phones are widely used since they have the advantages of both mobile phones and computers. A conventional smart phone is usually equipped with two cameras, one on its front surface and the other on its rear surface, but recently developed smart phones have two cameras on one of its front surface and rear surface, and another camera on the other surface.

In the case of a smart phone having two cameras installed on one surface, the optical axes of the two cameras need to be aligned parallel to each other.

When aligning the optical axes of two cameras, it is possible to use a chart having two marks that are spaced apart from each other by as much as the distance between the two cameras.

However, in the case of installing two cameras on a smart phone of a different model and thus the distance between the cameras changes, it is necessary to use a chart having a different distance between the two marks accordingly. Therefore, in the case of aligning cameras for a smart phone of a different module by using one optical axis alignment equipment, there is inconvenience of having to change the chart for each smart phone model, and to re-set the position of the chart every time the chart is changed.

Korean Application No. KR20120094668A teaches a stereo camera and a manufacturing method thereof are provided to provide a tool member accurately matching optical axes of a plurality of camera module, thereby precisely matching the optical axes for photographing 3D images. CONSTITUTION: A stereo camera comprises a plurality of camera modules and a tool member (130). The camera module comprises a plurality of joining members being outwardly projected and photographs 3D images of an external subject. The tool member comprises a plurality of mounting units where the camera modules are mounted and a plurality of seating units being joined to the camera modules.

Korean Application No. KR20160042694A teaches a right camera including a left image sensor and a right lens for supplying light to the left camera and the right image sensor and the right image sensor including a left lens for supplying light to the left side of the image sensor stereo image to that of a stereo camera that can be taken on the left side camera, and alignment of the alignment device and the stereo camera of the stereo camera to align each other the right camera and the left side to the center of the left lens coincides with the center of the left side of the image sensor the left control a first position on the image sensor of the lens and, based on the position information about the first position to adjust the second position on the right image sensor of the right lens is the first position and the second position car stereo to be aligned with each other It provides an alignment device and alignment of the stereo camera method of D.

### SUMMARY OF THE EMBODIMENTS

Therefore, a purpose of the present disclosure is to solve the aforementioned problems of prior art, that is, to provide an aligning method for dual camera module, capable of aligning the optical axes of the dual camera module with accuracy.

Another purpose of the present disclosure is to provide an aligning method for dual camera module, capable of easily aligning the optical axes of the dual camera module having a different distance between the camera modules using one alignment equipment.

The aforementioned purposes are achieved by an aligning method for dual camera module, the method comprising: a step of fixating a first camera module in a space inside a housing; a step of inserting a second camera module by moving the second camera module into the space inside the housing; a step of aligning the second camera module by aligning a position of the second camera module with reference to a position where the first camera module is fixated; and a step of fixating the second camera module in the space inside the housing.

Preferably, the method further comprises, between the step of inserting a second camera module and the step of aligning the second camera module, a step of preliminary alignment of a second camera module by preliminarily aligning the second camera module with reference to a second chart-photograph image obtained by photographing a chart with the second camera module.

Preferably, the chart includes a reference rectangle which is defined by a plurality of lines or dots and which has a first side to a fourth side, the second chart-photograph image consists of a rectangular having a first side to a fourth side, and the step of preliminary alignment of a second camera module includes: a step of matching centers which comprises matching a center of the second chart-photograph image and a center of the reference rectangle in the second chart-photograph image by tilting the second camera module with reference to an x axis and a y axis of the second camera module; and a step of aligning angles which comprises making the sides of the second chart-photograph image and the sides of the reference rectangle become parallel to each other, respectively.

Preferably, the step of aligning angles comprises: a step of z axis rotation which comprises rotating the second camera module with reference to the z axis so as to make a second average value become zero, the second average value being an average value of angles formed by each of the sides of the second chart-photograph image and each of the sides of the reference rectangle in the second chart-photograph image; and a step of xy axes tilting which comprises tilting the second camera module with reference to the x axis and the y axis of the second camera module so as to make the angles become zero.

Preferably, after the step of xy axes tilting, if the second average value is greater or smaller than 0 by a predetermined value, the step of z axis rotation is restarted.

Preferably, a chart includes a reference rectangle which is defined by a plurality of lines or dots and which has a first side to a fourth side; a first chart-photograph image in a rectangular shape is obtained by photographing the chart with the first camera module; a second chart-photograph image in a rectangular shape is obtained by photographing the chart with the second camera module; an average value of angles formed by each sides of the first chart-photograph image and each sides of the reference rectangle in the first chart-photograph image is a first average value; and an average value of angles formed by each sides of the second chart-photograph image and each of sides of the reference rectangle inside the second chart-photograph image is a second average value, and the step of aligning a second camera module comprises: a step of z axis alignment which comprises rotating the second camera module with reference to a z axis, to make the first average value identical to the second average value; and a step of xy axes alignment which comprises matching the angles formed by the second chart-photograph image and the reference rectangle and the angles formed by the first chart-photograph image and the reference rectangle, to become identical to each other.

Preferably, the second chart-photograph image is made by photographing the chart with the second camera module to make an original image, and then by moving the reference rectangle in the original image by a distance corresponding to a distance by which the first camera module and the second camera module are spaced apart.

Preferably, an aligning method for dual camera module is provided and the method comprises a step of comparing a first chart-photograph image obtained by photographing a chart having a reference figure defined by a plurality of lines or dots by means of a first camera module, with a second chart-photograph image obtained by photographing the chart by means of a second camera module, and a step of aligning the first camera module and the second camera module.

Preferably, the second chart-photograph image is made by photographing the chart with the second camera module to make an original image, and then by moving a reference figure in the original image by a distance corresponding to a distance by which the first camera module and the second camera module are spaced apart.

According to the aligning method for dual camera module according to the present disclosure, it is possible to align the optical axes of the camera modules with efficiency and accuracy.

Further, it is possible to easily align the optical axes for various dual camera modules having different distances between the camera modules.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present between two elements. Like reference numerals refer to like elements throughout.

FIG. 1 is a flowchart of an aligning method for dual camera module according to the present disclosure;

FIG. 2 is a view provided to explain each step of the aligning method for dual camera module according to the present disclosure;

FIG. 3 is a view provided to explain a step of preliminary alignment of second camera module in the aligning method for dual camera module according to the present disclosure;

FIG. 4 is a view provided to explain an image photographed when applying the aligning method for dual camera module according to the present disclosure;

FIG. 5 is a view provided to explain a step of aligning second camera module in the aligning method for dual camera module according to the present disclosure; and

FIG. 6 is a view provided to explain a second chart-photograph image used in the aligning method for dual camera module according to the present disclosure.

### DETAILED DESCRIPTION OF THE EMBODIMENTS

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention. Hereinbelow, specific embodiments of the present disclosure will be explained in detail with reference to the drawings.

An aligning method for dual camera module according to the present disclosure includes a step of fixating a first camera module (S1), a step of inserting a second camera module (S2), a step of aligning a second camera module (S4) and a step of fixating a second camera module (S5).

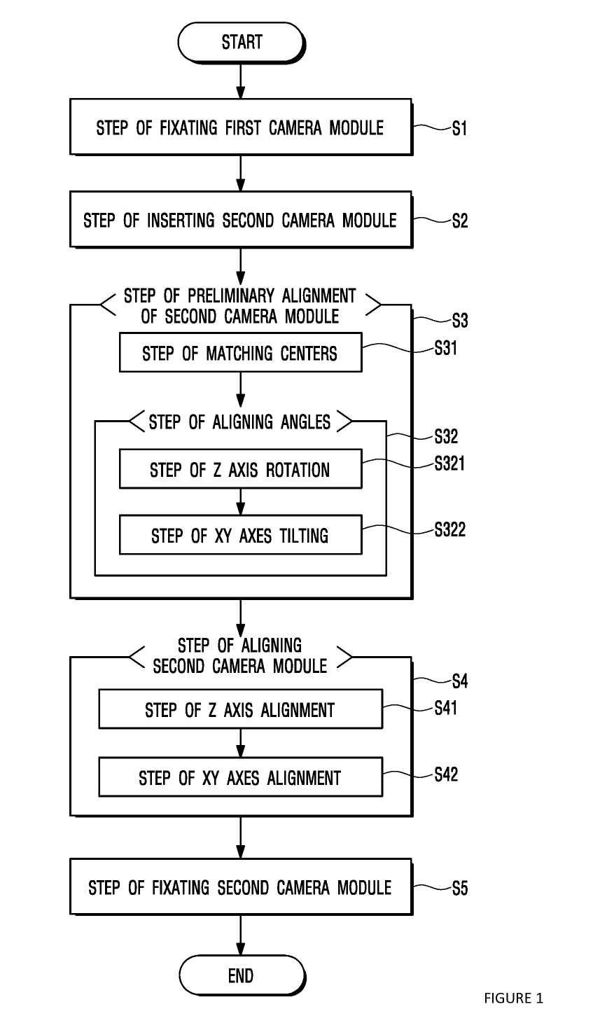

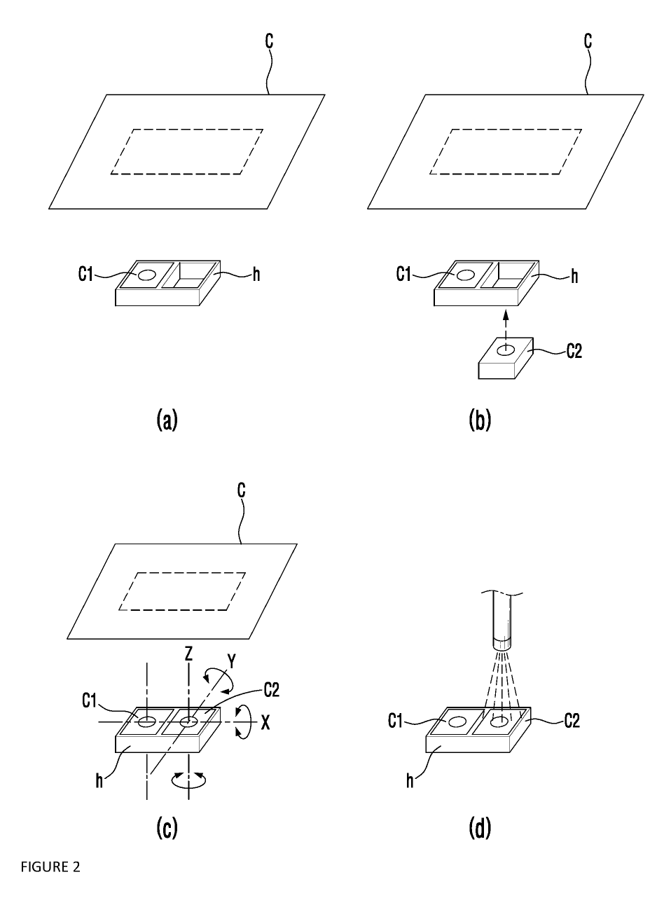

FIG. 1 illustrates a flowchart of the aligning method for dual camera module according to the present disclosure, and FIG. 2 illustrates a view provided to explain each step of the aligning method for dual camera module according to the present disclosure.

At the step of fixating first camera module (S1), as illustrated in (a) of FIG. 2, a first camera module C1 is inserted into a space inside a housing h, and is fixated.

For reference, the housing h has a space inside thereof, where the first camera module C1 and a second camera module C2 may be arranged side by side, and at this step, the first camera module C1 is arranged at one side of the space inside the housing h.

When fixating the first camera module C1, attention should be paid so that the first camera module C1 has a certain angle in a certain position inside the housing h, but there is no need to perform a separate calibration operation.

The housing h, in a state where the first camera module C1 is fixated thereto, is transferred to a position on a center of a lower portion of a chart C where a reference rectangle r is drawn.

At the step of inserting a second camera module (S2), as illustrated in (b) of FIG. 2, the second camera module C2 is inserted into the space inside the housing h, that is left after the first camera module C1 is arranged.

At the step of aligning second camera module (S4), as illustrated in (c) of FIG. 2, with reference to the first camera module C1 of which the position is fixated inside the housing h, the second camera module C2 is aligned. Aligning the second camera module C2 with the first camera module C1 is made by photographing the chart C with each of the first camera module C1 and the second camera module C2, then by comparing the photographed images with each other and by adjusting the position and angle of the second camera module C2. By the step of aligning a second camera module (S4), an optical axis of the first camera module C1 and an optical axis of the second camera module C2 become parallel to each other. For reference, at the step of aligning a second camera module (S4), the alignment is made in a state where a gripping arm, configured to move about six axes, is gripping the second camera module C2, and this state where the gripping arm is gripping the second camera module C2 is maintained until the second camera module C2 is completely fixated to the housing h.

At the step of fixating a second camera module (S5), as illustrated in (d) of FIG. 2, an adhesive is applied between the housing h and the second camera module C2 so that the second camera module C2 may be fixated to the housing h.

In the aligning method for dual camera module according to the present disclosure as aforementioned, only a general extent of attention is paid to the arrangement between the housing h and the camera module, while the relative position between the first camera module C1 and the second camera module C2 is calibrated with precision, thus increasing the efficiency of alignment operation of the dual camera module, and moreover, accurately calibrating the optical axis of the first camera module C1 and the optical axis of the second camera module C2 to be parallel to each other.

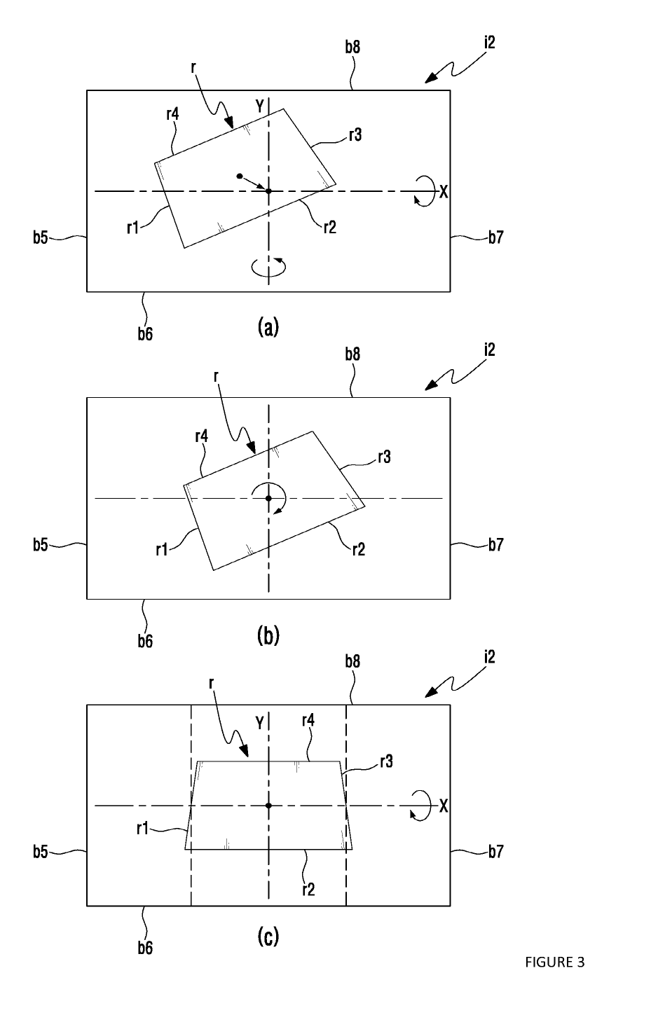

Between the step of inserting a second camera module (S2) and the step of aligning a second camera module (S4), there may be a step of preliminary alignment of a second camera module (S3). FIG. 3 illustrates a view provided to explain the step of preliminary alignment of second camera module (S3).

Aligning the second camera module C2 with reference to the first camera module C1 does not only relate to simply making the exterior of the first camera module C1 and the exterior of the second camera module C2 become parallel to each other, but relates to aligning the optical axis of the first camera module C1 and the optical axis of the second camera module C2 as aforementioned. Therefore, when the second camera module C2 is aligned with reference to the first camera module C1, images photographed with each of the first camera module C1 and the second camera module C2 should be expressed identically. That is, when aligning the second camera module C2 with reference to the first camera module C1, a photographing subject is needed, and the first camera module C1 and the second camera module C2 should have an identical angle with respect to the photographing subject. In other words, the photographing subject becomes a medium for aligning the first camera module C1 and the second camera module C2.

However, since the first camera module C1 does not go through a particular calibration process when it is fixated to the housing h, the first camera module C1 is not aligned with respect to the medium, chart C, and thus has a certain angle with respect to the chart C, making it not easy to directly align the second camera module C2 with respect to the first camera module C1. At the step of preliminary alignment of second camera module (S3), the second camera module C2 is calibrated with respect to the chart C, that is the photographing subject, and at the step of aligning a second camera module (S4), the second camera module C2 is aligned so that the angle of the first camera module C1 to the chart C and the angle of the second camera module C2 to the chart C become identical to each other, making it easier to align the second camera module C2 with the first camera module C1.

More specifically, at the step of preliminary alignment of a second camera module (S3), the angle of the second camera module C2 is calibrated with reference to the chart C where a reference rectangle r is drawn. On a second chart-photograph image i2 obtained by photographing the chart C with the second camera module C2, the reference rectangle r drawn on the chart C is shown. Here, if the optical axis of the second camera module C2 is not perpendicular to the surface of the chart C, the reference rectangle r may be positioned to one side on the second chart-photograph image i2 or may appear in a shape that is different from the actual shape, for example, in a trapezoid shape. Therefore, if the position and angle of the second camera module C2 is adjusted so that the reference rectangle r that appears on the second chart-photograph image i2 is positioned on a center of the second chart-photograph image i2 and four angles of the reference rectangle are all right angles, the second camera module C2 and the chart C are aligned to each other.

The step of preliminary alignment of second camera module (S3) may include a step of matching centers (S31) and a step of aligning angles (S32).

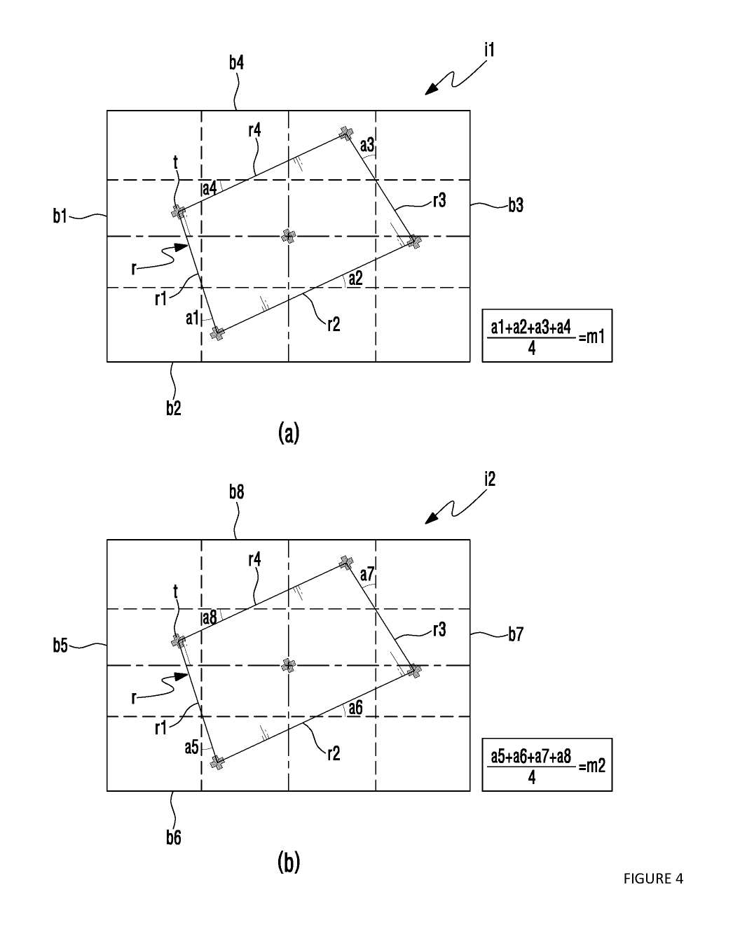

For reference, when applying the aligning method for dual camera module according to the present disclosure, the images of the chart C, photographed by each of the first camera module C1 and the second camera module C2 as aforementioned are used. Here, the reference rectangle r having a first side to a fourth side r1, r2, r3, r4 is drawn on the chart C, and each of the photographed images i1, i2 consists of a rectangle having a first side to a fourth side as well. FIG. 4 illustrates a view provided to explain such photographed images and such reference rectangles r appearing on the photographed images. The sides of the photographed images i1, i2 and the sides of the reference rectangles r corresponding thereto are indicated in identical numbers, respectively. For example, as illustrated in FIG. 4, the first sides b1, b5 of the photographed images i1, i2 represent the line segments positioned on the left side, and the first side r1 of the reference rectangle r represents the line segment positioned on the left side as well.

The reference rectangle r drawn on the chart C may be displayed with four line segments. Further, as illustrated in FIG. 4, by displaying a vertex portion and a central point portion, it is possible to calculate the reference rectangle r based on the vertex and the central point. It is preferable that corners and center of the reference rectangle r are displayed in a certain pattern or shape so as to be clearly recognized. In FIG. 4, a cross symbol t is used, for example. Further, it is preferable that the image being drawn on the chart C is a quadrangle of which all four angles are perpendicular, that is, a square or a rectangle, but the image may have other shapes such as a triangle, hexagon, and grid shape etc.

At the step of matching centers (S31), as illustrated in (a) of FIG. 3, the second camera module C2 is tilted with reference to an x axis and a y axis, so that the center of the second chart-photograph image i2 and the center of the reference rectangle r appearing on the second chart-photograph image i2 match each other. For reference, the x axis, y axis and z axis are the axes of the gripping arm that is gripping the second camera module C2, the x axis and the y axis being parallel to the surface of the chart C, and the z axis being perpendicular to the surface of the chart C.

Since the housing h where the second camera module C2 is arranged is positioned on the center of a lower portion of the chart C, the center of the second chart-photograph image i2 and the center of the reference rectangle r should match each other, but if the optical axis of the second camera module C2 is significantly deviated with reference to the axis that penetrates the center of the chart C, the center of the reference rectangle r will significantly deviate from the center of the second chart-photograph image i2. At the step of matching centers (S31), the second camera module C2 is tilted with reference to the x axis and the y axis so that the optical axis of the second camera module C2 and the axis that penetrates the center of the chart C match each other to some extent.

Further, at the step of aligning angles (S32), as illustrated in (b) and (c) of FIG. 3, the second camera module C2 is moved more minutely with reference to the x axis, y axis and z axis so that the sides of the second chart-photograph image i2 and the sides of the reference rectangle r corresponding thereto are parallel to each other, respectively.

The step of aligning angles (S32) may include a step of z axis alignment (S321) and a step of xy axes tilting (S322).

As illustrated in (b) of FIG. 4, in the second chart-photograph image i2, an angle formed by the first side b5 of the second chart-photograph image i2 and the first side r1 of the reference rectangle r is called a first angle a5, an angle formed by the second side b6 of the second chart-photograph image i2 and the second side r2 of the reference rectangle r is called a second angle a6, an angle formed by the third side b7 of the second chart-photograph image i2 and the third side r3 of the reference rectangle r is called a third angle a7, and an angle formed by the fourth side b8 of the second chart-photograph image i2 and the fourth side r4 of the reference rectangle r is called a fourth angle a8.

Here, at the step of z axis rotation (S321), as illustrated in (b) of FIG. 3, the second camera module C2 is rotated with reference to the z axis so that an average value of the first angle to the fourth angle a5, a6, a7, a8 becomes 0 (zero), and this average value is a second average value m2, defined as follows.

m2=(a5+a6+a7+a8)/4

For reference, making the second average value m2 become zero does not mean making it exactly zero, but does mean making the value approach zero. Also, making a value of the first angle become zero means making the angle approach zero.

After the step of z axis rotation (S321), in the second chart-photograph image i2 and the reference rectangle r, each of the angles a5, a6, a7, a8 approaches 0 or has an almost identical magnitude but with an opposite direction. For example, as illustrated in (c) of FIG. 3, the second angle a6 and the fourth angle a8 approach 0, and the first angle a5 and the third angle a7 have an almost identical magnitude but with an opposite direction, making the average value of the first angle to the fourth angle a5, a6, a7, a8 approach zero.

At the step of xy axes rotation (S322), the second camera module C2 is tilted with reference to the x axis and the z axis so that each of the first angle to the fourth angle a5, a6, a7, a8 becomes zero. The first angle to the fourth angle a5, a6, a7, a8 being zero means that the optical axis of the second camera module C2 and the axis that penetrates the center of the chart C match each other.

For example, as illustrated in (c) of FIG. 3, after the step of z axis rotation (S321), the first angle a5 and the third angle a7 not being zero means that the y axis of the second camera module C2 is tilted, and thus a distance between a portion positioned in a positive (+) direction of the y axis on the second camera module C2 and the chart C is different from a distance between a portion positioned in a negative (−) direction of the y axis on the second camera module C2 and the chart C. Therefore, by tilting the second camera module C2 with reference to the x axis at the step of xy axes rotation (S322), it is possible to make the distance between the portion positioned in the positive (+) direction of the y axis on the second camera module C2 and the chart C become identical to the distance between the portion positioned in the negative (−) direction of the y axis on the second camera module C2 and the chart C.

After going through the step of z axis rotation (S321), if not only the first angle a5 and the third angle a7 but also the second angle a6 and the fourth angle a8 are not 0, it is obvious that the second camera module C2 should be tilted with reference to not only the x axis but also the y axis.

After going through the step of xy axes rotation (S322), if the second average value m2 is greater or smaller than zero by a certain extent, it is possible to return to the step of z axis rotation (S321).

The reason why the first angle to the fourth angle are not zero after the step of z axis rotation (S321) may not only be because the second camera module C2 is tilted about the x axis or the y axis, but also be because the second camera module C2 is not rotated sufficiently about the z axis.

Therefore, after the step of xy axes rotation (S322), if the second average value m2 is measured again and this re-measured second average value m2 is greater or smaller than zero by a predetermined extent, that is, if it is confirmed that the second camera module C2 is not calibrated sufficiently with reference to the z axis, it is possible to return to the step of z axis rotation (S321) and then to rotate the second camera module C2 with reference to the z axis, thereby calibrating the second camera module C2 more accurately.

At the step of aligning a second camera module (S4), the chart C is photographed using each of the first camera module C1 and the second camera module C2 as mentioned above, and the reference rectangle r of the chart C is expressed identically in each photographed image.

For reference, the image obtained by photographing the chart C where the reference rectangle r is drawn with the first camera module C1 is called the first chart-photograph image i1, and as illustrated in (a) of FIG. 4, the angle formed by the first side b1 of the first chart-photograph image i1 and the first side r1 of the reference rectangle r is called the first angle a1, the angle formed by the second side b2 of the first chart-photograph image i1 and the second side r2 of the reference rectangle r is called the second angle a2, the angle formed by the third side b3 of the first chart-photograph image i1 and the third side r3 of the reference rectangle r is called the third angle a3, and the angle formed by the fourth side b4 of the first chart-photograph image i1 and the fourth side r4 of the reference rectangle r is called the fourth angle a4. Further, the average value of these first angle to the fourth angle a1, a2, a3, a4 are called the first average value m1, the first average value m1 being as follows.

m1=(a1+a2+a3+a4)/4

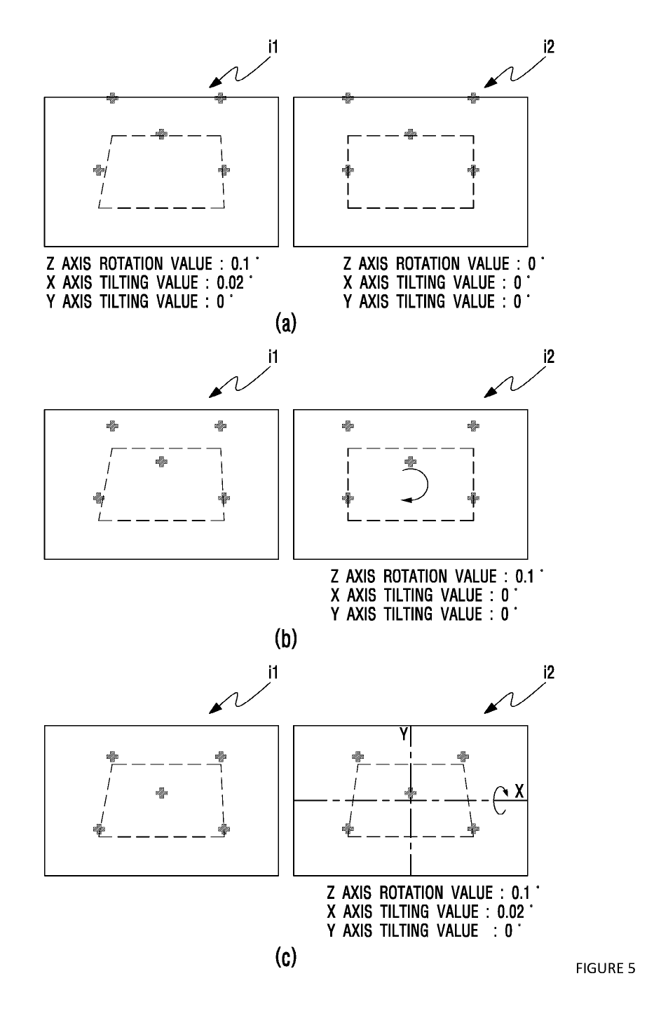

After the step of preliminary alignment of a second camera module (S3), as illustrated in (a) of FIG. 5, the second camera module C2 which was calibrated with respect to the chart C has a z axis rotation value, x axis tilting value and y axis tilting value, that are all 0 (zero), and the fact that calibration was made may be confirmed by the fact that the reference rectangle r in the second chart-photograph image i2 is expressed in a complete rectangular shape. However, in the first chart-photograph image i1 by the first camera module C1, that was not particularly calibrated with respect to the chart C, the reference rectangle r is not expressed in a complete rectangular shape, and the z axis rotation value, x axis tilting value and y axis tilting value of the first camera module C1 are confirmed through the image of the reference rectangle r expressed in the first chart-photograph image i1. In other words, the step of aligning a second camera module (S4) is a step of matching the z axis rotation values, x axis tilting values and y axis tilting values of the first camera module C1 and the second camera module C2 to become identical to each other, respectively.

The step of aligning a second camera module (S4) includes a step of z axis alignment (S41) and a step of xy axes alignment (S42).

At the step of z axis alignment (S41), as illustrated in (b) of FIG. 5, the second camera module C2 is rotated with reference to the z axis so that the first average value m1 and the second average value m2 match each other. Accordingly, the z axis rotation value of the second camera module C2 and the z axis rotation value of the first camera module C1 become identical to each other.

Further, at the step of xy axes alignment (S42), as illustrated in (c) of FIG. 5, the second camera module C2 is tilted with reference to the x axis and the y axis so that the first angle to the fourth angle a5, a6, a7, a8 of the reference rectangle r in the second chart-photograph image i2 match the first angle to fourth angle a1, a2, a3, a4 of the reference rectangle r in the first chart-photograph image i1, respectively. Accordingly, the x axis tilting value and the y axis tilting value of the second camera module C2 become identical to the x axis tilting value and the y axis tilting value of the first camera module C1, respectively.

For example, in the case where the first camera module C1 has the x axis tilting value and the y axis of the first camera module is aligned to the y axis of the chart C as illustrated in FIG. 5, that is, where the y axis tilting value is 0, the second camera module C2 needs to be tilted with respect to the x axis only, at the step of xy axes alignment (S42).

By the step of z axis alignment (S41) and the step of xy axes alignment (S42), the angle of the second camera module C2 with respect to the chart C becomes identical to the angle of the first camera module C1 with respect to the chart C, and thus the optical axis of the first camera module C1 and the optical axis of the second camera module C2 become parallel to each other.

Generally, since the first camera module C1 and the second camera module C2 are arranged so that they are spaced apart from each other side by side, in order to align the optical axes of the first camera module C1 and the second camera module C2, on the chart C, there should be two reference rectangles r having a distance that corresponds to the distance by which the first camera module C1 and the second camera module C2 are spaced apart from each other. However, in the present disclosure, the use of the chart C having one reference rectangle r makes it possible to have the same effect as the use of the chart C having two reference rectangles r.

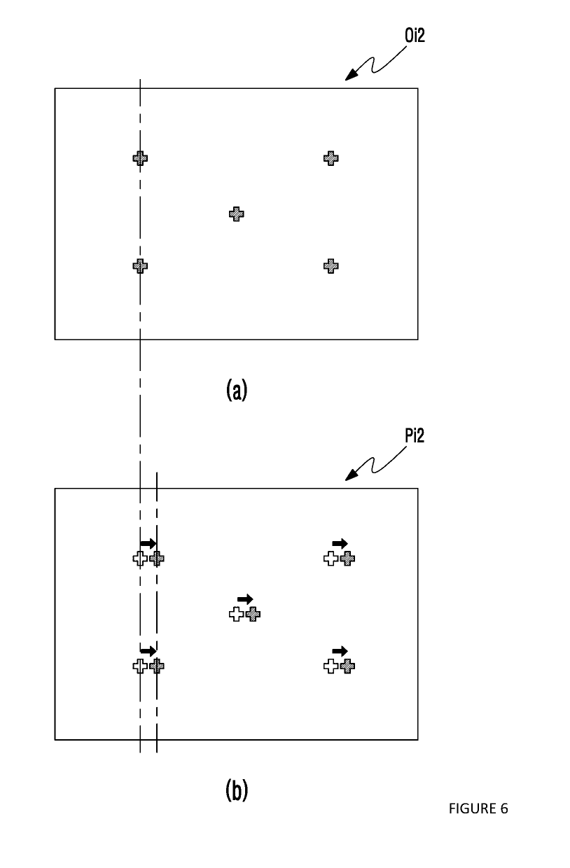

That is, as the first chart-photograph image i1, the image of the chart C photographed using the first camera module C1 can be used as it is. However, as the second chart-photograph image i2, a processed image Pi2 is used and the processed image is made by photographing the chart using the second camera module C2 to obtain an original image Oi2, and then by moving the reference rectangle r in this original image Oi2 by as much as the distance corresponding to the distance by which the first camera module C1 and the second camera module C2 are spaced apart, as illustrated in FIG. 6.

Accordingly, even when the distance between the first camera module C1 and the second camera module C2 changes due to changes in specifications of the device on which the dual camera module is mounted, there is no need to prepare a plurality of charts suitable to each dual camera module, and further, when aligning different dual camera modules with one optical axis alignment equipment, there is no need to change the chart per dual camera module, thereby reducing inconvenience which requires the setting of a position of the chart.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

In the drawings and specification, there have been disclosed typical embodiments of the invention, and although specific terms are employed, they are used in a generic and descriptive sense only and not for purposes of limitation. It will be understood by those of ordinary skill in the art that various changes in form and details may be made therein without departing from the spirit and scope of the present invention as defined by the following claims.

What is claimed is:

1. An aligning method for dual camera module, the method comprising:
a step of fixating a first camera module in a space inside a housing;
a step of inserting a second camera module by moving the second camera module into the space inside the housing;
a step of aligning the second camera module by aligning a position of the second camera module with reference to a position where the first camera module is fixated; and
a step of fixating the second camera module in the space inside the housing.

2. The method according to claim 1,
further comprising between the step of inserting a second camera module and the step of aligning the second camera module, a step of preliminary alignment of a second camera module by preliminarily aligning the second camera module with reference to a second chart-photograph image obtained by photographing a chart with the second camera module.

3. The method according to claim 2,
wherein the chart includes a reference rectangle which is defined by a plurality of lines or dots and which has a first side to a fourth side,
the second chart-photograph image consists of a rectangular having a first side to a fourth side, and
the step of preliminary alignment of a second camera module includes:
a step of matching centers which comprises matching a center of the second chart-photograph image and a center of the reference rectangle in the second chart-photograph image by tilting the second camera module with reference to an x axis and a y axis of the second camera module; and
a step of aligning angles which comprises making the sides of the second chart-photograph image and the sides of the reference rectangle become parallel to each other, respectively.

4. The method according to claim 3,
wherein the step of aligning angles comprises:
a step of z axis rotation which comprises rotating the second camera module with reference to the z axis so as to make a second average value become zero, the second average value being an average value of angles formed by each of the sides of the second chart-photograph image and each of the sides of the reference rectangle in the second chart-photograph image; and
a step of xy axes tilting which comprises tilting the second camera module with reference to the x axis and the y axis of the second camera module so as to make the angles become zero.

5. The method according to claim 4,
after the step of xy axes tilting, if the second average value is greater or smaller than 0 by a predetermined value, the step of z axis rotation is restarted.

6. The method according to claim 1,
wherein a chart includes a reference rectangle which is defined by a plurality of lines or dots and which has a first side to a fourth side; a first chart-photograph image in a rectangular shape is obtained by photographing the chart with the first camera module; a second chart-photograph image in a rectangular shape is obtained by photographing the chart with the second camera module; an average value of angles formed by each sides of the first chart-photograph image and each sides of the reference rectangle in the first chart-photograph image is a first average value; and an average value of angles formed by each sides of the second chart-photograph image and each of sides of the reference rectangle inside the second chart-photograph image is a second average value, and
the step of aligning a second camera module comprises:
a step of z axis alignment which comprises rotating the second camera module with reference to a z axis, to make the first average value identical to the second average value; and
a step of xy axes alignment which comprises matching the angles formed by the second chart-photograph image and the reference rectangle and the angles formed by the first chart-photograph image and the reference rectangle, to become identical to each other.

7. The method according to claim 6,
wherein the second chart-photograph image is made by photographing the chart with the second camera module to make an original image, and then by moving the reference rectangle in the original image by a distance corresponding to a distance by which the first camera module and the second camera module are spaced apart.

8. An aligning method for dual camera module,
comprising a step of comparing a first chart-photograph image obtained by photographing a chart having a reference figure defined by a plurality of lines or dots by means of a first camera module, with a second chart-photograph image obtained by photographing the chart by means of a second camera module, and
a step of aligning the first camera module and the second camera module.

9. The method according to claim 8,
wherein the second chart-photograph image is made by photographing the chart with the second camera module to make an original image, and then by moving a reference figure in the original image by a distance corresponding to a distance by which the first camera module and the second camera module are spaced apart.
